(19) United States
(12) Patent Application Publication
(10) Pub. No.: US 2025/0178444 A1
(43) Pub. Date: Jun. 5, 2025

(54) ARM ASSEMBLY FOR ENERGY TRANSFER SYSTEM

(71) Applicant: Caterpillar Inc., Peoria, IL (US)

(72) Inventors: Igor STRASHNY, Tucson, AZ (US); Jason SCHAFER, Rapid City, SD (US)

(73) Assignee: Caterpillar Inc., Peoria, IL (US)

(21) Appl. No.: 18/525,092

(22) Filed: Nov. 30, 2023

(51) Int. Cl. B60L 5/38; B60L 5/08

(52) U.S. Cl. CPC B60L 5/38; B60L 5/08

(57) ABSTRACT

An electricity-conducting connector assembly for connecting a free-steering mobile machine to a stationary electricity source while moving includes an electricity-conducting boom assembly including a proximal end and a distal end, the proximal end of the boom assembly movably connected to a body of the mobile machine; an electricity-conducting arm assembly including a proximal end and a distal end, the proximal end of the arm assembly connected to the distal end of the boom assembly; and an electricity-conducting contactor assembly connected to the distal end of the arm assembly. The arm assembly includes at least three longitudinally extendable arms arranged parallel to one another.

### TECHNICAL FIELD

The present disclosure relates generally to an electricity-conducting arm assembly for a mobile machine and, more specifically, an arm assembly having a plurality of parallel arms forming a portion of an energy transfer system of the mobile machine.

### BACKGROUND

Mobile industrial machines, such as earth-moving machines, can be of substantial weight and can bear immense loads, thus requiring a large amount of power. Many industrial machines are driven by internal combustion engines. However, internal combustion engines have drawbacks such as fuel costs, fuel transport difficulties, and detrimental engine emissions. Accordingly, there has been a movement toward powering large mobile industrial machines with hybrid or all-electric power systems.

While hybrid and all-electric power systems for industrial machines are beneficial for alleviating fuel costs and emission concerns, these systems present challenges. For example, the use of hybrid or all-electric systems in an industrial capacity requires a significant investment in infrastructure, particularly due to the location of industrial worksites. While the use of overhead electricity-conducting lines is one solution for powering vehicles with predetermined routes or terrain (e.g., trains, subways, buses, etc.), overhead lines are not practical for all machines or worksites, such as freely-steerable industrial machines and worksites with uneven terrain. As a result, existing power systems, such as overhead lines, are not typically used in remote and uneven environments. Other problems include reliably coupling freely-steerable industrial machines to a power source.

A system for providing electric power to a traveling vehicle is described in International Patent App. Pub. No. WO 2020/186296 A1, published on Sep. 24, 2020 (“the '296 publication”). The system described in the '296 publication describes an electrical delivery system at a mine site for a moving vehicle where two conductors are anchored to relocatable roadside barriers. In order to charge the moving vehicle, the delivery system requires that an arm must precisely engage with electrical connectors embedded within a horizontal channel of the roadside barriers. While the system described in the '296 publication may be helpful in some circumstances, the '296 publication does not describe details on how to position the arm of the electrical delivery system to couple with the roadside electrical conductors.

Aspects of the present disclosure may solve one or more of the problems set forth above and/or other problems in the art. The scope of the current disclosure, however, is defined by the attached claims, and not by the ability to solve any specific problem.

### SUMMARY

In one aspect, an electricity-conducting connector assembly for connecting a free-steering mobile machine to a stationary electricity source while moving includes an electricity-conducting boom assembly including a proximal end and a distal end, the proximal end of the boom assembly movably connected to a body of the mobile machine; an electricity-conducting arm assembly including a proximal end and a distal end, the proximal end of the arm assembly connected to the distal end of the boom assembly; and an electricity-conducting contactor assembly connected to the distal end of the arm assembly. The arm assembly includes at least three longitudinally extendable arms arranged parallel to one another.

In another aspect, an electricity-conducting connector assembly for connecting a free-steering mobile machine to a stationary electricity source while moving includes an electricity-conducting boom assembly including a proximal end and a distal end, the proximal end of the boom assembly movably connected to a body of the mobile machine; an electricity-conducting arm assembly including a proximal end and a distal end, the proximal end of the arm assembly connected to the distal end of the boom assembly; and an electricity-conducting contactor assembly connected to the distal end of the arm assembly. The arm assembly including a plurality of telescoping arms extending parallel to one another, and the electricity-conductivity of the arm assembly is dependent on a telescoping position.

In yet another aspect, a method of supplying electricity from a stationary electricity source to a free-steering mobile machine, the free-steering mobile machine including an electricity-conducting connector assembly including an electricity-conducting boom assembly, an electricity-conducting arm assembly connected to the boom assembly, and an electricity-conducting contactor assembly connected to arm assembly, the method includes pneumatically extending the arm assembly to transition from a non-electricity-conducting capability to an electricity-conducting capability.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of an electric mobile machine connected to an electricity-conducting rail system, according to aspects of the present disclosure.

FIG. 2 is a perspective view of a trailing arm assembly and contactor assembly of the mobile machine of FIG. 1.

FIG. 3 is a perspective view of proximal end portions of the trailing arm assembly of FIGS. 1 and 2.

FIGS. 4A-4C are views of an individual trailing arm and its components in a fully-extended state, a sectional view of the fully-extended state, and a retracted state, respectively.

FIG. 5 is a perspective view of a distal end of the trailing arm assembly connected to the contactor assembly.

FIG. 6 is a flowchart illustrating a method for extending and conducting electrical energy along the trailing arm assembly.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

As used herein, the terms “upstream” and “proximal” are intended to locationally identify components, parts, assemblies, and systems located closer to the frame/body of the mobile machine. Conversely, the terms “downstream” or “distal” are intended to locationally identify components, parts, assemblies, and systems located farther away from the frame/body of the mobile machine.

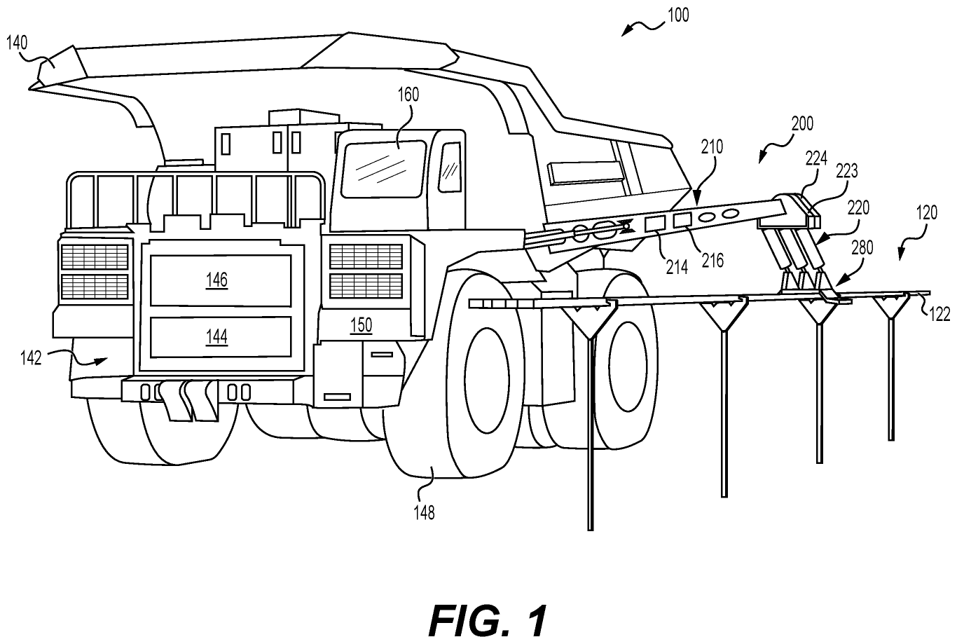

FIG. 1 depicts a mobile machine power system 100, according to aspects of the present disclosure. The mobile machine power system 100 includes a mobile machine 140 having an electricity-conducting connector assembly 200, and an electricity-conducting rail system 120 for providing electric power to the mobile machine 140. The mobile machine 140 includes an electric drive system 142 having at least one electric motor 144 and at least one battery system 146. The electric drive system 142 drives a set of ground-engaging elements 148, such as tires or continuous tracks, for propelling and maneuvering the mobile machine 140. The mobile machine 140 also includes a frame/body 150 which supports the mobile machine's mechanical components, including the electricity-conducting connector assembly 200. Mobile machine 140 may utilize either a hybrid or an all-electric power systems, and the electricity-conducting rail system 120 may be applied to either system. Mobile machine 140 and its various systems may be controlled via a machine operator located in the operator cabin 160, and/or mobile machine 140 may be semi- or fully-autonomous or remotely operated.

The mobile machine 140 is free-steering, allowing the operator of the machine (or autonomous control system) to freely control the direction and route of the machine. Thus, the exemplary mobile machine 140 is configured to travel (e.g., in a free-steering manner) selectively along a work route or path within a job site, with the electricity-conducting rail system 120 positioned generally along the route or path. The mobile machine 140 of FIG. 1 is shown in the context of a mining truck which is commonly utilized for transporting ore in a mine environment. The present disclosure is not so limited, however, and other types of machines are within the scope of the present disclosure, including articulated trucks, asphalt pavers, backhoe loaders, drills, rope shovels, excavators, forest machines, hydraulic mining shovels, material handlers, motor graders, off-highway trucks, pipelayers, road reclaimers, telehandlers, track loaders, underground mining dump loaders and trucks, wheel loaders, wheel tractor-scrapers, or other machines.

The electricity-conducting rail system 120 includes a plurality of elevated conductor rails 122 connected to a power source (e.g., a power grid, generator, and/or energy storage devices, not shown). While FIG. 1 shows an example where the plurality of conductor rails 122 contains three conductor rails, the plurality of conductor rails 122 may contain fewer or more rails. In this example, two of the conductor rails provide electrical power at different polarities (e.g., a conductor rail with a positive polarity and a conductor rail with a negative polarity) while the third conductor rail provides a reference of 0 volts (ground). The elevated conductor rails 122 may have a height in the range of 8 to 15 feet above the ground, for example. Thus, the electricity-conducting rail system does not form a pantograph-type overhead power system, nor an under-machine or low-ground-located power system.

The electricity-conducting connector assembly 200, as shown in FIG. 1 electrically connects the mobile machine 140 to the electricity-conducting rail system 120. The electricity-conducting connector assembly 200 includes a boom assembly 210 having a proximal end and a distal end; an arm assembly, such as a trailing arm assembly 220 having a proximal end connected to the distal end of the boom assembly 210; and a contactor assembly 280 connected to a distal end of the trailing arm assembly 220. As used herein, the term “trailing” refers to a direction opposite the forward direction of travel of the mobile machine 140. The boom assembly 210 houses a hydraulic system 214 for pivotably extending, retracting, and locking the boom assembly 210, and a pneumatic system 216 for generating and controlling fluid pressure of downstream components (e.g. the trailing arm assembly 220 and the contactor assembly 280), and an integrated busbar (not shown) for transferring electrical energy along a length of the boom assembly 210.

As shown in FIG. 1 the boom assembly 210 extends generally horizontally from a side of the mobile machine and is connected to a side of the frame/body 150 of the mobile machine 140 about a pivot joint (not shown). The pivot joint is located at a height of over 8 feet on the machine (above the ground). As previously referenced, the electricity-conducting connector assembly 200 includes several different states of deployment, including an extended state in which the boom assembly 210 is extended outward away from a side of the mobile machine 140 (as shown in FIG. 1), a retracted state (not shown) in which the boom assembly is rotated inward to rest against the frame/body 150 of the mobile machine (not shown), and a locked state in which the boom assembly is locked to the side of the machine frame/body 150 in the retracted state by a hydraulically-actuated locking pin (not shown). Finally, while the boom assembly 210 is shown to be attached to a mining truck, the same boom assembly 210 is capable of being incorporated in various types of mobile machines 140 by use of an interchangeable adapter (not shown) that is specific to the type of machine being operated.

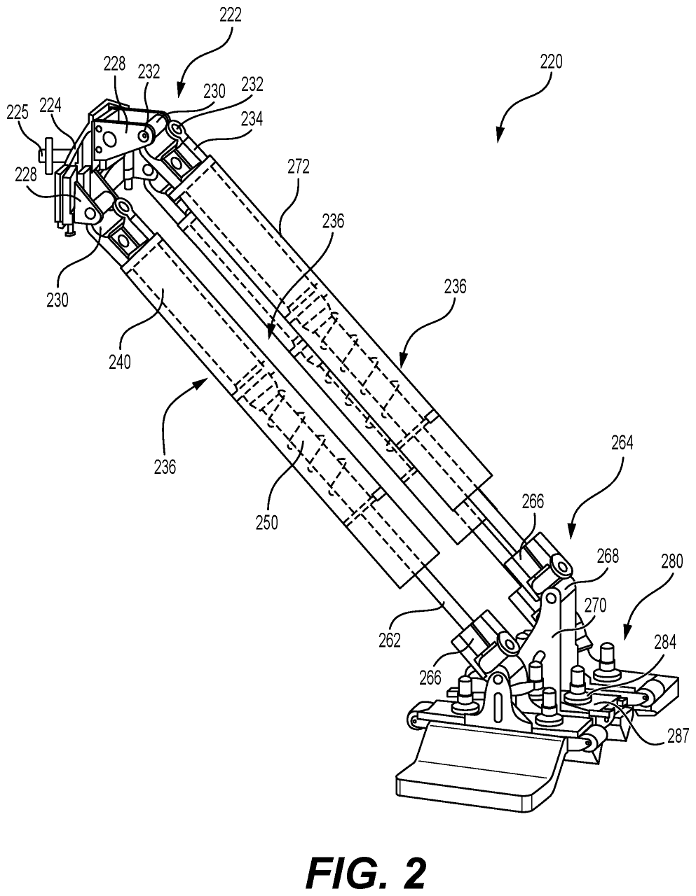

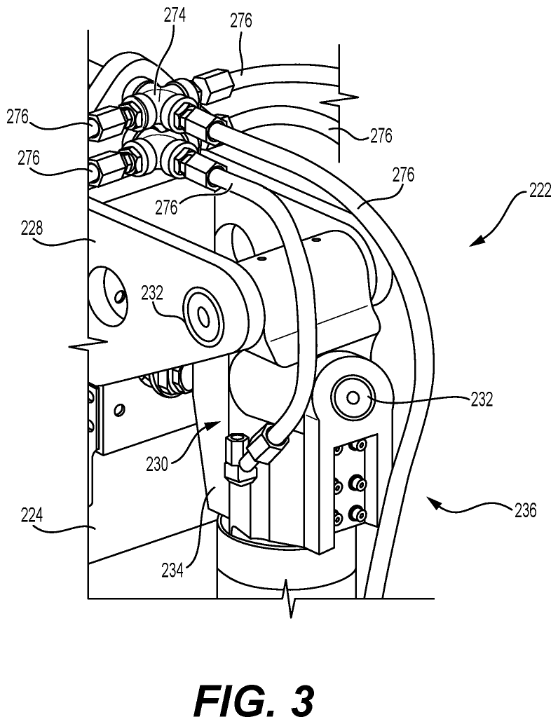

Referring to FIGS. 1 and 2, the trailing arm assembly 220 includes a boom connection assembly 222, a plurality of trailing arms 236, and a contactor connection assembly 264. The exemplary trailing arm assembly illustrated includes three longitudinally extending trailing arms 236, however, it is understood that more or less trailing arms 236 could be included. The trailing arm assembly 220 is attached to a distal end of the boom assembly 210 by the boom connection assembly 222 (best shown in FIGS. 2 and 3), which allows for the movement of the plurality of trailing arms 236 with multiple degrees of freedom independent of the movement of the boom assembly 210. The multiple degrees of freedom provide the electricity-conducting connector assembly 200 with lateral freedom (e.g., freedom in a horizontal direction that is substantially perpendicular to the running direction of the plurality of conductor rails 122) and vertical freedom (e.g., freedom in a substantially vertical direction relative to a difference in height between a deployed height of the boom assembly and the height of the conductor rails 122) to adjust to the electricity-conducting rail system 120 during use of the mobile machine 140. More specifically, the trailing arm assembly 220 accommodates changes in relative position between plurality of conductor rails 122 and mobile machine 140 during travel. For example, the trailing arm assembly 220 comprises a lateral operating range of up to approximately ten feet, and a vertical operating range of up to approximately five feet.

FIGS. 1 and 2 also show the contactor assembly 280 attached to a distal end of the trailing arm assembly 220 (via the contactor connection assembly 264) and extends behind the boom assembly 210 and the trailing arm assembly 220 with respect to the forward direction of travel of the mobile machine 140. In operation, the contactor assembly 280 is configured to be electrically connected to the electricity-conducting rail system 120. For example, as shown in FIG. 1, the contactor assembly 280 slides along a top planar surface of the plurality of conductor rails 122, allowing the electrical energy to be transmitted from the contactor assembly 280 to the trailing arm assembly 220. As will be explained in more detail below, the electrical energy is routed from trailing arm assembly 220 (only when in the fully-extended position) to the integrated busbar that runs along the length of the boom assembly 210. The energy is subsequently transferred to the mobile machine 140 and directed to the at least one electric motor 144 and/or the at least one battery system 146.

FIG. 3 illustrates a first or proximal end portion of the trailing arm assembly 220, specifically a portion of the boom connection assembly 222 for mechanically and electrically connecting the individual trailing arms 236 to the boom assembly 210. Only one trailing arm 236 is shown in FIG. 3. The boom connection assembly 222 includes a connection plate 224 for connection with a similar connection plate 223 (FIG. 1) on the boom assembly 210. A spherical bearing (not shown) may be included between the connection plates 223, 224 to allow for relative movement between the trailing arm assembly 220 and the boom assembly 210. In particular, as shown in FIG. 2, a spindle or connecting rod 225 may couple connection plate 224 with connection plate 223 of the boom assembly 210, and the spindle 225 may receive a spherical bearing (not shown) that includes an outer ring secured within an opening of the connection plate 224.

The boom connection assembly 222 further includes a plurality of first U-shaped brackets 228, a plurality of first or proximal conductive joints 230, and a plurality of mechanical fasteners 232. As shown in FIG. 3, the plurality of first U-shaped brackets 228 are fixed to an outer face of the connection plate 224 (opposite the spherical bearing). As shown in FIG. 2, the U-shaped brackets 228 can be arranged in a vertically staggered configuration to allow for the unimpeded movement of the individual trailing arms 236. In such a vertically staggered configuration, the central trailing arm may be secured vertically higher than two vertically aligned side trailing arms. The first or proximal group of conductive joints 230 are attached to the plurality of first U-shaped brackets 228 at a first end of the first conductive joints 230, with the first conductive joints 230 being retained in the U-shaped brackets via a mechanical fasteners 232. The individual first conductive joints 230, in turn, are mechanically and electrically connected to an individual first yoke 234 of each trailing arm 236 at a second end. The first or proximal conductive joints 230 can be in any form, such as a conductive joint using liquid metal between moving parts. Further the first conductive joints 230 may be bi-directional and only allowing movement in two directions, such a vertical movement and lateral movement, as will be described in more detail below.

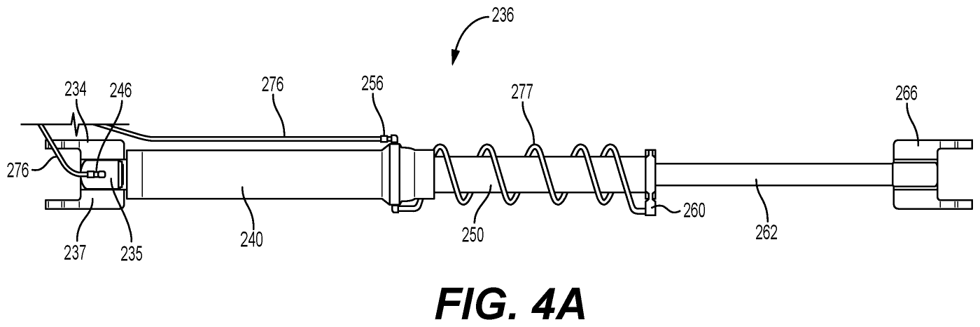

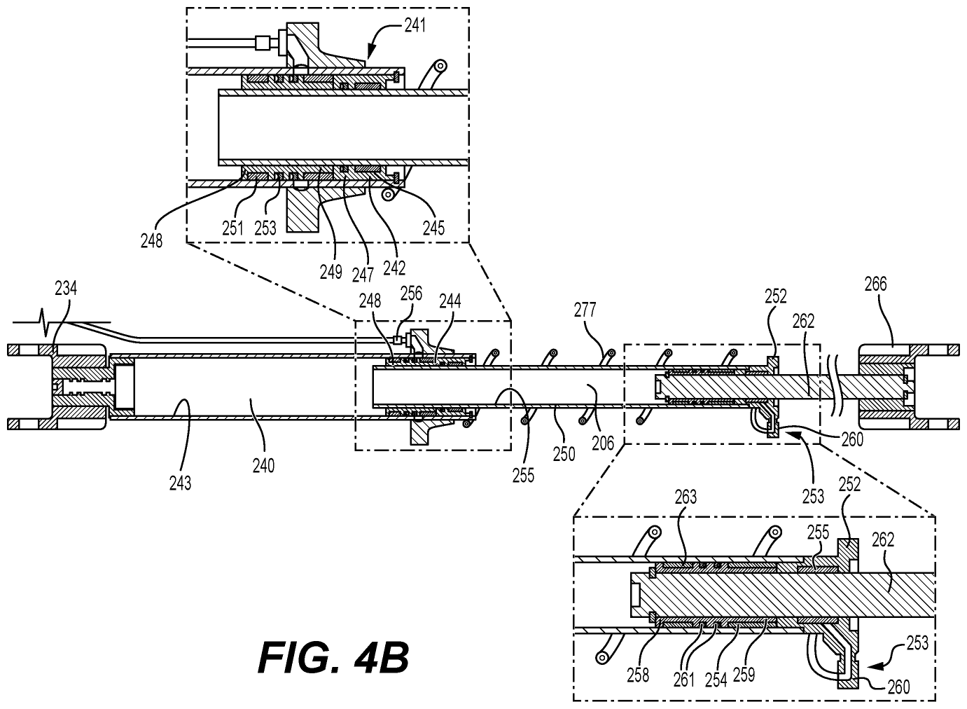

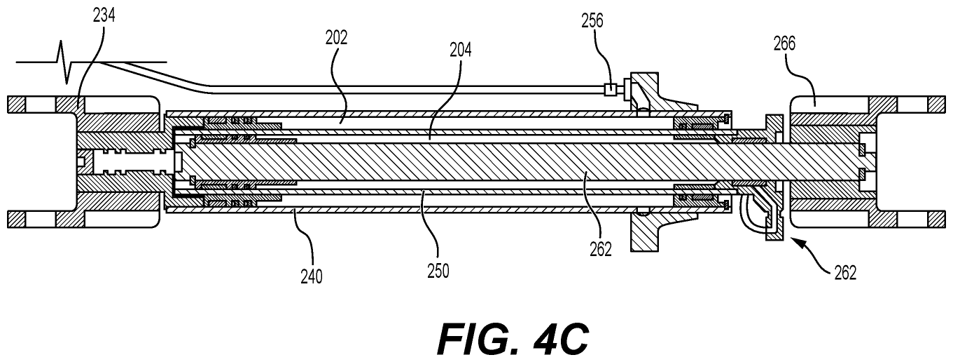

FIG. 3 also depicts the connection plate 224 including a pneumatic hub 274, which is connected to the pneumatic system 216 located within the housing of the boom assembly 210. The pneumatic hub 274 acts as a junction point for a plurality of pneumatic tubes 276, enabling the supply of pressurized fluid to travel from the pneumatic system 216 (in the boom assembly 210) to the plurality of trailing arms 236 for extending and retracting the telescoping trailing arms 236. For example, an individual pneumatic tube 276 connects the pneumatic hub 274 to the first yoke 234 of the central trailing arm 236, with additional pneumatic tubes attaching to other pneumatic connection points located on the plurality of trailing arms (best shown in FIGS. 4A-4C). Each of the plurality of trailing arms 236 are pneumatically sealed and become pressurized with the supply of the pneumatic fluid.

It should be noted that, as shown in FIG. 2, each of the individual trailing arms 236 may include a stationary (non-telescoping) arm cover 272 coupled to a proximal end of the trailing arm assembly 220 for protecting the trailing arms 236 when not in use. The arm cover 272 may tubular in shape and may be made of any appropriate material and may include, for example, dielectric materials such as pultruded fiberglass-reinforced polymer (FRP), or other electrically insulating or dielectric materials. The length of the cover 272 may generally correspond to a length of the trailing arms 236 when in a fully retracted condition.

FIGS. 4A-4C illustrates a side view of an individual trailing arm 236. In operation, the trailing arm assembly 220 is capable of multiple configurations or states, including longitudinally extending to a fully-extended state in which the trailing arm assembly 220 is configured to conduct electrical energy along its length (shown in FIGS. 1, 2, and 4), a stowed state in which the trailing arm assembly is slightly extended to place the contactor assembly 280 in contact with a portion of the frame 150 of the mobile machine (not shown), and a retracted state in which the trailing arm assembly is retracted into a nested configuration (shown in FIGS. 4A-4C). In the retracted state, the contactor assembly 280 is not attached to or in contact with the plurality of conductor rails 122 and the trailing arm assembly 220 cannot conduct electricity in this collapsed configuration.

Each of the plurality of trailing arms 236 includes a pair of yokes (e.g. the first, proximal yoke 234 mentioned above, and a second, distal yoke 266) located at opposite ends of each trailing arm 236, and a plurality of telescoping links. The plurality of telescoping links 238 include an upper or proximal link 240, a middle link 250, and a lower or distal link 262, with the links having various sizes and shapes (e.g., lengths, outer diameters, inner diameters, etc.). For example, upper link 240 and middle link 250 may be electricity-conducting cylinders or tubes, and the lower link 262 could be an electricity-conducting cylinder or rod. In the arrangement shown, the lower link 262 is a solid rod. In such an arrangement middle link 250 slides longitudinally within upper link 240, and lower link 262 slides longitudinally within middle link 250. The telescoping links 238 may be formed of any conductive material, such as aluminum. Such aluminum links 238 may include inner and/or outer anodized layers as will be discussed in more detail below. Further, each of the telescoping links may be sized (e.g. thickness, length, etc.) to have approximately the same current carrying capacity.

Reference will now be made to one trailing arm 236 in FIGS. 4A-4C, however, the features disclosed are equally applicable to the other trailing arms 236. A first or proximal yoke 234 is attached to a first or proximal end of the upper link 240. The first yoke 234 includes a central block 235 and a pair of side arms 237 connected to the central block 235. The central block 235 includes a pneumatic connection 246 in order to supply the upper link 240 with pressurized fluid from the pneumatic system 216.

Upper link 240 further includes a distal assembly 241 fixedly secured to a distal end inner diameter 243 of the upper link 240. The distal assembly may include an annual bearing housing 242 and an annular electrical socket 244 located proximal and immediately adjacent the bearing housing 242. The annular bearing housing 242 may include an inner facing sleeve bearing 245 and a seal 247. The bearing housing 242 forms a seal between an inner surface of the upper link 240 and an outer surface of the middle link 250. The inner diameter 243 of upper link 240 may include an anodized layer, however the anodized layer 243 may be fully or partially removed where the electrical socket 244 contacts the inner diameter 243 of upper link 240, as will be explained in more detail below.

As noted above, the middle link 250 is retained and slidable within the sealed upper link 240. The middle link 250 includes a piston 248 fixedly secured to an outer surface of a proximal or upper end of the middle link 250. The piston 248 may include an annular electrical pin or plug portion 249 at a distal end of the piston 248, the pin portion 249 sized for being received in the electrical socket 244 of the upper link 240 when the middle link 250 is in a fully-extended position. The piston 284 may further include a pair of radially outwardly extending seals 253 and a sleeve bearing 251 proximal the seals 253. As will be explained in more detail below, when the middle link 250 is fully extended, the electrical pin portion 249 is received in electrical socket 244, and a radially-directed electrical connection is formed between middle link 250 and upper link 240.

Upper link 240 further includes a pneumatic connection 256 for suppling pressurized fluid to a first retraction chamber 202 formed between an outer surface of middle link 250 and an inner surface of upper link 240, and sealed by way of piston 248 of middle link 50 and bearing housing 242 of the upper link 240.

The distal end of middle link 250 also includes a distal assembly 253 including a bearing housing end ring 252 and an annular electrical socket 254 secured adjacent and proximal the bearing housing end ring 252. The bearing housing end ring 252 may be fixedly secured to an inner diameter of the middle link and include an annular sleeve bearing 255 on an inner surface of the bearing housing end ring, and may include a pneumatic fitting 260 and passageway for supplying air to a second retraction chamber 204, as will be described in more detail below. Bearing housing end ring 252 forms a seal between an inner surface of the middle link 250 and an outer surface of the lower link 262. The middle link 250 further includes an anodized layer on an inner surface 255 of the middle link 250, however the anodized layer may be fully or partially removed where an outer surface of the electrical socket 254 contacts the middle link 250, as will be explained in more detail below.

The lower link 262 is retained and slidable within the middle link 250. The lower link 262 includes a piston 258 secured to an outer surface of a proximal or upper end of the lower link 262. The piston 258 includes a proximal portion for securing a pair of radially outwardly extending seals 261 and an annular bearing 263, and a distal annular electrical plug or pin portion 259 formed at a distal end of piston 258. The pin portion 259 is sized for being received in the electrical socket 254 of the middle link 250 when the lower link 262 is in a fully-extended position. As will be explained in more detail below, when the lower link 262 is extended, the electrical pin portion 259 is received in electrical socket 254, and a radially-directed electrical connection is formed between lower link 263 and the middle link 250.

As noted above, middle link 250 includes a lower link pneumatic connection 260 in the bearing housing end ring 252 for connecting and supplying pressurized fluid to the second retraction chamber 204 formed between an outer surface of lower link 262 and an inner surface of middle link 250. The second retraction chamber 204 is sealed by the piston 258 on the lower link 262 and the bearing housing end ring 252 of middle link 250.

The interior chambers of the upper link 240 and middle link 250 together form a common extension chamber 206 that receives fluid from pneumatic connection 246 to extend trailing arm 236. Pneumatic connections 256 and 260 are fluidly connected to one another via a pneumatic tube 277, and supply fluid to the first and second retraction chambers 202, 204, respectively, to retract trailing arm 236.

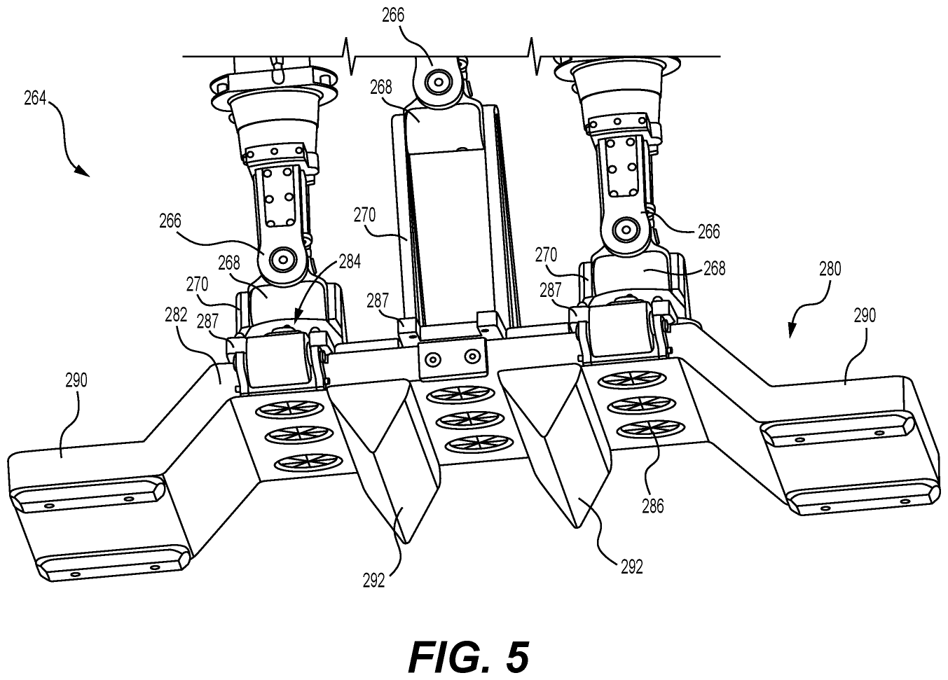

Similar to the boom connection assembly 222 above, the contactor connection assembly 264 includes a plurality of second or distal brackets 270 and a plurality of second or distal conductive joints 268. The second conductive joints 268 are similar or identical to the first conductive joints 230 discussed above. As shown in FIG. 5, each of the plurality of second conductive joints 268 are mechanically and electrically connected to an individual second or distal yoke 266 at a first end. The plurality of second or distal brackets 270, which are attached to a top surface of the contactor assembly 280, are also attached to a second end of the plurality of second conductive joints 268. Each second end of the plurality of second conductive joints 268 is electrically connected to the contactor assembly 280, allowing for electrical power to be introduced to the trailing arm assembly 220.

FIG. 5 illustrates the contactor assembly 280 including a base frame 282 in which a plurality of conducting terminals 284 and busbars 287 are secured. In an exemplary configuration that includes three conductor rails 122, the contactor assembly 280 includes nine total conducting terminals 284 arranged in a three-by-three matrix, such that the three groups of linear conducting terminals 284 each correspond to one of a positive polarity conductor rail, a negative polarity conductor rail, and a conductor rail providing a reference of 0 volts (ground). Furthermore, each individual conducting terminal 284 includes an extendable brush 286, with each conducting terminal 284 being fluidly connected to the pneumatic system 216 to control extension and retraction of the brushes 286 to assist in coupling and decoupling the brushes 286 from the conductor rails 122. In one example air is supplied to the conducting terminals 284 via a passage (not shown) in lower link 262 and a manifold assembly connected to the conducting terminals 284. The contactor assembly 280 may include three busbars 287 located on a top surface of base frame 282, and electrically connected between the conducting terminals 284 and the distal brackets 270. The contactor assembly 280 further includes a plurality of retention features to assist in maintaining the connection of the contactor assembly 280 with the plurality of conductor rails 122. For example, the base frame 282 may include a pair of lateral flanges or wings 290 located on opposite lateral sides of the base frame 282, as well as a pair of rail engagement members 292 that separate the respective groups of conducting terminals 284 from each other. Individual groups of conducting terminals 284 align with the individual conductor rails 122, and the individual rail engagement members 292 align with gaps extending between the conductor rails 122.

### INDUSTRIAL APPLICABILITY

The disclosed aspects of the trailing arm assembly 220 above can be used for deploying and electrically connecting a free-steering mobile machine 140 to an electricity-conducting rail system 120 for charging while moving along a worksite. For example, the figures depict the extension of the trailing arm assembly from a retracted, non-conductive state to a fully-extended, conductive state (FIGS. 4A-4C) and the multiple degrees of freedom provided in order to adjust to the position of the plurality of conductor rails 122 relative to the electricity-conducting connector assembly 200.

The flow of electricity from the conducting rail system 120 through the connector assembly 200 will now be discussed. As noted above, electricity can only be conveyed through the trailing arms 236 when the trailing arms 236 are in their fully-extended position (FIGS. 4A and 4B). Thus, the trailing arms 236 are pneumatically extended to transition from a non-electricity-conducting capability to an electricity-conducting capability. Electricity is provide by the electrically-conducting rail system 120 and first travels through the contactor assembly 280 via the brushes 286 associated conducting terminals 284, and then through the plurality of top mounted busbars 287. From there, the electricity is provided to the distal brackets 270, through the distal conductive joint 268, and through distal yoke 266 to the lower link 262. When in the fully-extended position (FIG. 4B), lower link 262 conducts electricity axially to electrical pin portion 259, and then in a radial manner from electrical pin portion 259 of the lower link 262 to the electrical socket 254, and then to the middle link 250. Middle link 250 then conducts the electricity axially to the electrical pin portion 249, then radially from the electrical pin portion 249 of the middle link 250 to the electrical socket 244 of the upper link 140, and then axially up the upper link 240. Electricity is then conveyed through proximal yoke 234, through proximal conductive joint 230 to the proximal bracket 228, and then to electric cables (not shown) that supply the current to the integrated busbar of the boom assembly 210. As noted above, the inner surfaces 243, 255 of the upper link 240 and middle link 250, and the outer surface of lower link 262 each include an anodized layer, respectively that ensure that current is only conveyed via the pistons housings 248, 258 and sockets 244, 254.

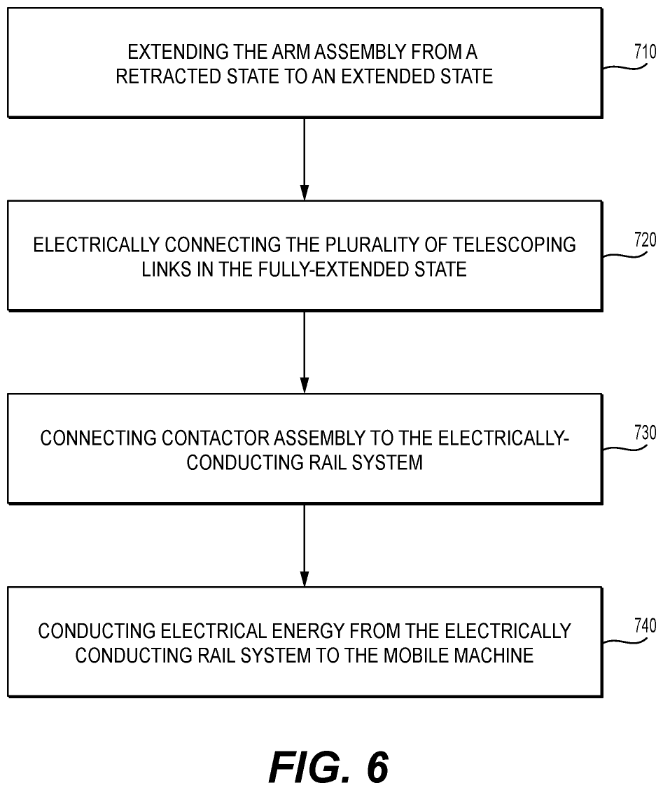

FIG. 6 is a flowchart illustrating an exemplary method 700 for connecting the trailing arm assembly 220 to the electricity-conducting rail system 120 and conducting electrical power to a free-steering mobile machine 140, according to aspects of the present disclosure. Prior to the performance of method 700, the trailing arm assembly 220 may be in a retracted state, as shown in FIG. 4C. While in this retracted state, the plurality of telescoping links are in a nested configuration, with the upper links 240 retaining the middle links 250 and the lower links 262. Also, prior to fully extending the plurality of telescoping links 238, the plurality of trailing arms 236 are unable to conduct electrical power.

Step 710 may include extending the plurality of telescoping links 238 of the trailing arm assembly 220 from a first retracted state to a second, extended state using a pneumatic system 216. The pneumatic system 216, which is housed within the boom assembly 210, pressurizes a fluid and distributes the fluid to the downstream components (e.g., the trailing arm assembly 220 and the contactor assembly 280) via a plurality of pneumatic tubes 276, 277, 278 (FIG. 5). During the extension of the plurality of telescoping links 238, the pneumatic system 216 supplies fluid pressure to the common extension chamber 206 in upper link 240 and middle link 250 sufficient to allow each link of the individual trailing arms 236 to fully extend from the first retracted state to the second extended state in parallel.

Step 720 of the method 700 includes electrically connecting the plurality of telescoping links 238 along a length of the trailing arm assembly 220 in the manner discussed above. In particular, step 720 includes moving each of the telescoping links 238 to their fully-extended positions so that an electrical path is formed through the telescoping links 238.

Step 730 includes locating and connecting contactor assembly 280 to the electricity-conducting rail system 120. This may involve aligning and placing the contactor assembly 280 on the plurality of conductor rails 122 in order to connect the plurality of conducting terminals 284 with the conductor rails.

In Step 740, the method 700 includes the step of conducting electrical energy from the electricity-conducting rail system 120, though the contactor assembly 280, along the plurality of telescoping links 238 of the trailing arm assembly 220, and to boom assembly 210 of the mobile machine 140. As discussed above, the electrical power is routed from the contactor assembly 280 through the trailing arm assembly to the integrated busbar of the boom assembly 210, which transfers the electrical power to the at least one battery system 146 of the mobile machine 140.

In accordance with the present disclosure, the trailing arm assembly 220 for the mobile machine 140 assists in providing a system with structural strength, reduced weight, appropriate degrees of freedom, and robust electrical connections. For example, the three, parallel trailing arms 236 form a double parallel linkage that provides both strength and appropriate degrees of freedom. The bi-directional movement (vertically and laterally) of the two conductive joints 230, 268, along with the movement allowed by the spherical bearing coupled between the boom assembly 210 and trailing arm assembly 220, assist in obtaining an appropriate degree of freedom to accommodate (1) alignment of the trailing arm assembly with the electricity-conducting rail system 120, and (2) instantaneous compensation for certain, lateral, and angular shifts of the mobile machine with respect to the electricity-conducting rail system 120. However, the degree of freedom of the system helps to limit undesirable angular and rotational movement. The use of pneumatic system can help reduce the weight of the system as compared to using a hydraulic system for controlling the trailing arm assembly 220 and contactor assembly 280. Furthermore, the telescoping links of the trailing arm assembly 220 allow for a nested or retracted state when not in use. Finally, due to the electrical connection of the telescoping links 236, the trailing arm assembly allows for transfer of large currents (e.g. greater than 2000 Amps), and only conducts electrical energy when deployed in the extended state, thus providing an additional layer of safety.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. An electricity-conducting connector assembly for connecting a free-steering mobile machine to a stationary electricity source while moving, comprising:
an electricity-conducting boom assembly including a proximal end and a distal end, the proximal end of the boom assembly movably connected to a body of the mobile machine;
an electricity-conducting arm assembly including a proximal end and a distal end, the proximal end of the arm assembly connected to the distal end of the boom assembly; and
an electricity-conducting contactor assembly connected to the distal end of the arm assembly;
the arm assembly including at least three longitudinally extendable arms arranged parallel to one another.

2. The electricity-conducting connector assembly according to claim 1, wherein each of the at least three arms are telescoping arms.

3. The electricity-conducting connector assembly according to claim 2, wherein each of the at least three arms are moved between a fully-extended position and a retracted position pneumatically.

4. The electricity-conducting connector assembly according to claim 3, wherein each of the at least three arms are electricity-conducting only in the fully-extended position.

5. The electricity-conducting connector assembly according to claim 4, wherein each of the at least three telescoping arms include a proximal first tube, a second tube slidable in the first tube, and a distal rod slidable in the second tube.

6. The electricity-conducting connector assembly according to claim 1, wherein each of the at least three arms include a proximal end coupled to a bi-directional conductive joint allowing movement of the at least three arms vertically and laterally.

7. The electricity-conducting connector assembly according to claim 6, wherein each of the at least three arms include a distal end coupled to a bi-directional conductive joint allowing movement of the at least three arms vertically and laterally.

8. The electricity-conducting connector assembly according to claim 7, wherein the proximal end of the arm assembly is coupled to the distal end of the boom assembly through a spherical bearing to provide relative movement between boom assembly and the arm assembly.

9. The electricity-conducting connector assembly according to claim 1, wherein the arm assembly is a trailing arm assembly with respect to the boom assembly and a forward direction of travel of the mobile machine.

10. The electricity-conducting connector assembly according to claim 9, wherein the boom assembly extends generally horizontally from a side of the mobile machine, is pivotable from the side of the machine, and is located at a height of over 8 feet on the machine.

11. The electricity-conducting connector assembly according to claim 10, wherein the contactor assembly includes a plurality of extendable brushes for contacting the stationary electricity source.

12. The electricity-conducting connector assembly according to claim 11, wherein the brushes are moved pneumatically from fluid provided to the arm assembly.

13. The electricity-conducting connector assembly according to claim 10, wherein the mobile machine is a mining machine.

14. An electricity-conducting connector assembly for connecting a free-steering mobile machine to a stationary electricity source while moving, comprising:
an electricity-conducting boom assembly including a proximal end and a distal end, the proximal end of the boom assembly movably connected to a body of the mobile machine;
an electricity-conducting arm assembly including a proximal end and a distal end, the proximal end of the arm assembly connected to the distal end of the boom assembly; and
an electricity-conducting contactor assembly connected to the distal end of the arm assembly;
the arm assembly including a plurality of telescoping arms extending parallel to one another, and the electricity-conductivity of the arm assembly is dependent on a telescoping position.

15. The electricity-conducting connector assembly according to claim 14, wherein each of the plurality of arms are moved between a fully-extended position and a retracted position pneumatically.

16. The electricity-conducting connector assembly according to claim 14, wherein each of the plurality of arms are electricity-conducting only in a fully-extended telescoping position.

17. The electricity-conducting connector assembly according to claim 14, wherein each of the plurality of telescoping arms include a proximal first tube, a second tube slidable in the first tube, and a distal rod slidable in the second tube.

18. The electricity-conducting connector assembly according to claim 14, wherein each of the plurality of arms include a pair of bi-directional conductive joints allowing movement of the at least three arms vertically and laterally.

19. The electricity-conducting connector assembly according to claim 14, wherein the boom assembly extends generally horizontally from a side of the mobile machine, is pivotable from the side of the machine, and is located at a height of over 8 feet on the machine.

20. A method of supplying electricity from a stationary electricity source to a free-steering mobile machine, the free-steering mobile machine including an electricity-conducting connector assembly including an electricity-conducting boom assembly, an electricity-conducting arm assembly connected to the boom assembly, and an electricity-conducting contactor assembly connected to arm assembly, the method comprising pneumatically extending the arm assembly to transition from a non-electricity-conducting capability to an electricity-conducting capability.
